(19) United States
(12) Patent Application Publication
(10) Pub. No.: US 2012/0103880 A1
(43) Pub. Date: May 3, 2012

(54) FUEL FILTER HAVING INTEGRATED SENSORS

(76) Inventors: Zhouxuan Xia, Windsor (CA); Hans Jensen, Dettingen (DE); Kevin Mulkeran, Holly, MI (US); Darren Johnson, Romulus, MI (US)

(21) Appl. No.: 12/912,885

(22) Filed: Oct. 27, 2010

(51) Int. Cl. F02M 37/22; B01D 35/02; B29C 45/14

(52) U.S. Cl. 210/85; 264/272.14; 210/167.02

(57) ABSTRACT

A fuel filter assembly for an internal combustion engine includes a molded plastic housing defining an interior filter chamber. A filter element is operatively supported in the filter chamber. Fuel is passed through the filter chamber to remove impurities. At least one sensor is operatively supported by the housing for sensing at least one condition of the fuel passing through the fuel filter. The sensor includes an element that is exposed to the fuel. A common connector terminal is adapted to provide electrical communication with a source of power. Leads extend between the element and the common connector terminal. The leads are encased in plastic substantially between the element and the common connector terminal such that the leads are sealed from contact with the fuel. The present invention is also directed toward a method of manufacturing a fuel filter for an internal combustion engine.

### BACKGROUND OF THE INVENTION

1. Field of the Invention

The present invention is directed toward a fuel filter, and more specifically, to a fuel filter having integrated sensors.

2. Description of the Related Art

Fuel filters are well known devices used to remove impurities from fuel that is then routed to an internal combustion engine. Fuel filters of the type commonly known in the related art include a housing as well as a filter element supported in the housing. Fuel is passed through the filter element as a means of removing the above-mentioned impurities. In addition, some fuel filters are known to incorporate sensors that sense various conditions of the fuel. In this case, the fuel filter housing is formed with separate ports through which the individual sensors receive access to the fuel. More specifically, the sensors are typically mounted in these separate ports formed in the housing for this purpose. Each sensor also must be installed and sealed with respect to the housing typically by using threaded brass inserts, o-rings, and possibly other fastening devices. These additional components and assembly time raise the cost of manufacturing the fuel filter.

There is an ongoing effort to seek ways to reduce the cost of any given component associated with the internal combustion engine. Yet, heretofore, the separately mounted and installed sensors have been generally accepted as the state of the fuel filter art, despite the costs of manufacture and assembly associated with this technology.

### SUMMARY OF THE INVENTION

The present invention overcomes the deficiencies in the related art in a fuel filter assembly for an internal combustion engine that includes a molded plastic housing defining an interior filter chamber. A filter element is operatively supported in the filter chamber. Fuel is passed through the filter chamber to remove impurities. At least one sensor is operatively supported by the housing for sensing at least one condition of the fuel passing through the fuel filter. The sensor includes an element that is exposed to the fuel. A common connector terminal is adapted to provide electrical communication with a source of power. Leads extend between the element and the common connector terminal. The leads are encased in plastic substantially between the element and the common connector terminal such that the leads are sealed from contact with the fuel. Thus, the sensor assembly is integrated into the fuel filter housing and formed during the process of molding the housing.

The present invention is also directed toward a method of manufacturing a fuel filter for an internal combustion engine. The method includes the step of placing at least one sensor including an element and leads in a mold cavity. Molten plastic is then injected into the mold cavity so as to define a filter housing having an interior filter chamber through which fuel may pass and so that the element of the sensor is exposed to fuel passing through the fuel chamber. At the same time, the leads are encased in molded plastic.

In this way, the added cost associated with threaded brass inserts, o-rings, and other fastening components, as well as the cost of assembling the sensor assembly to the housing are eliminated.

### BRIEF DESCRIPTION OF THE DRAWINGS

Other advantages of the invention will be readily appreciated as the same becomes better understood by reference to the following detailed description when considered in connection with the accompanying drawings, wherein:

FIG. 1 is a perspective view of one embodiment of the present invention showing the common connector terminal located on the body of the housing;

FIG. 2 is a perspective view of another embodiment of the present invention showing the common connector terminal as well as the sensor disposed on the cap of the housing;

FIG. 3 is a partial cross-sectional side view of the filter assembly of the present invention illustrating the sensor molded into the housing of the assembly;

FIG. 4 is a perspective view illustrating the leads of the sensors of the present invention as they are stamped from metal blanks;

FIG. 4B illustrates the leads of the sensors of the present invention formed from metal blanks and with plastic bindings used to maintain a gap between adjacent leads; and

FIG. 4C is a perspective view of the leads of the sensors of the present invention after the metal links have been stripped therefrom.

### DETAILED DESCRIPTION OF THE INVENTION

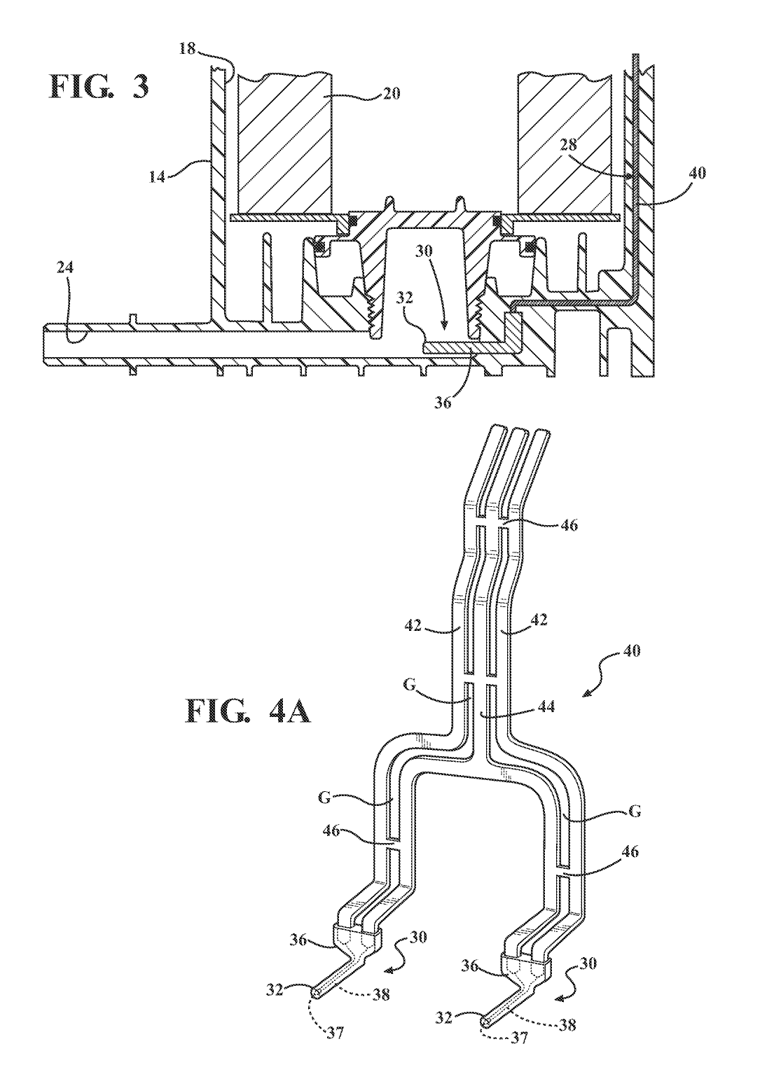

Referring now to the drawings, where like numerals are used to describe like features throughout the figures, a fuel filter assembly for an internal combustion engine is generally indicated at 10. The fuel filter assembly 10 includes a molded plastic housing, generally indicated at 12. The housing 12 includes a body 14 and a cap 16. Typically, the cap 16 may be removably mounted to the body 14. More specifically, in some instances, the cap 16 may be threadably mounted to the body 14 of the housing 12. To this end, the cap 16 and body 14 may include cooperating threads, as well as any suitable seal as commonly known in the art. Together, the body 14 and cap 16 define an interior filter chamber 18, as best shown in FIG. 3. A filter element 20 is operatively supported in the filter chamber 18 and fuel is passed through the filter chamber 18 and the filter element 20 as a means of removing impurities from the fuel. Thus, the housing 12 includes an inlet 22 that provides fluid communication between a source of fuel and the fuel chamber 18. Typically, the source of fuel includes a fuel tank. An outlet 24 provides fluid communication between the filter chamber 18 and the internal combustion engine. A return port 26 provides fluid communication between the filter chamber 18 and the source of fuel. Those having ordinary skill in the art will appreciate that the fuel filter 10 need not be mounted adjacent to or directly on the internal combustion engine or the source of fuel. Thus, it will be appreciated that there may be conduits and other components disposed between the fuel filter 10 and the internal combustion engine as well as the fuel tank without departing from the scope of the present invention. In addition, the fuel filter assembly 10 of the present invention may have other components and structural elements that are designed for the efficient operation of the assembly and which are commonly known in the related art but which are not discussed in detail here.

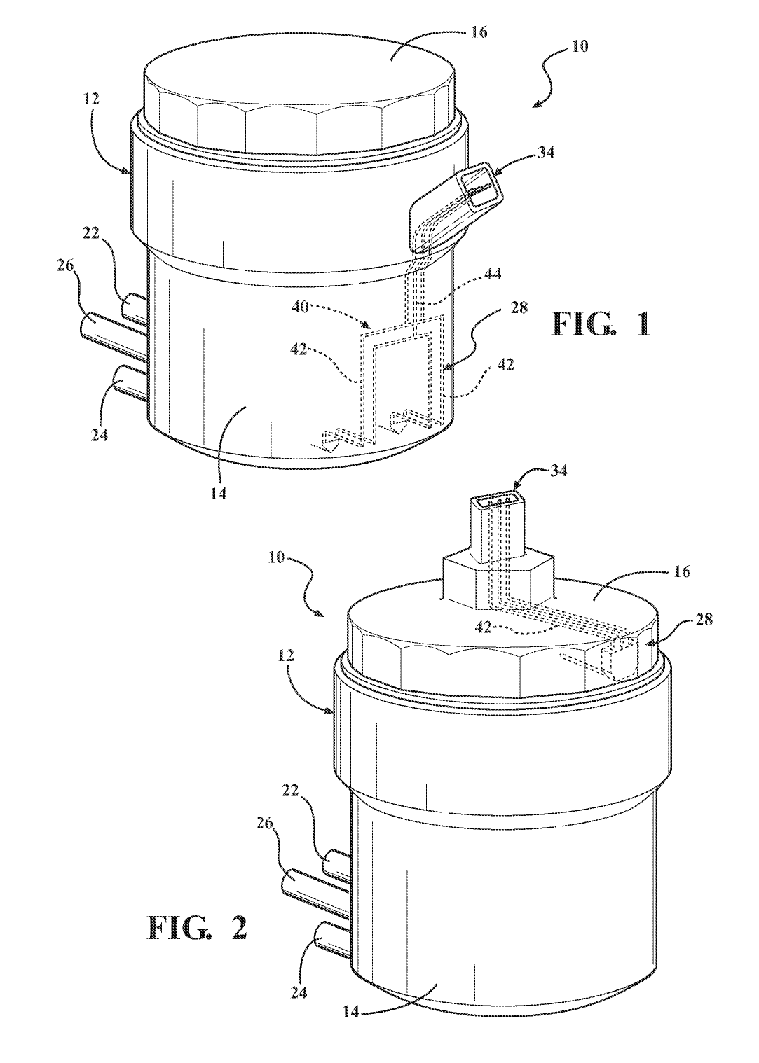

In addition, the fuel filter assembly 10 includes at least one sensor, generally indicated at 28, that is operatively supported by the housing for sensing at least one condition of the fuel passing through the filter assembly 10. As illustrated in FIG. 1-2, in one embodiment the assembly 10 may also include a plurality of sensors 28 illustrated in phantom, that are operatively supported in the housing 12 for sensing a plurality of conditions of the fuel passing through the filter assembly 10. The sensors 28 may be employed to sense the temperature, pressure, viscosity or any other condition of the fuel as may be desired or necessary in any given fuel delivery system. Whether the fuel filter assembly 10 includes a single sensor or multiple sensors, each of the sensors 28 include an element assembly 30 that includes an element 32 that is exposed to the fuel. The assembly 10 also includes a common connector terminal 34 that is adapted to establish electrical communication between a source of power and each of the sensor element assemblies 30. The term “common connector terminal” as used herein designates a single connector terminal that services each of the sensors 28, no matter how many sensors are employed for the fuel filter assembly 10. To this end, the common connector terminal 34 may be formed in the body 14, as illustrated in FIG. 1, or it may be formed in the cap 16, as illustrated in FIG. 2. Where the common connector terminal 34 is formed in the cap 16, the sensors 28 may also be operatively mounted in the cap 16 as illustrated in FIG. 2. However, those having ordinary skill in the art will appreciate from the description that follows that the structure of the integrated sensors is the same whether the sensors 28 and common connector terminal 34 are formed in the body 14 as illustrated in FIG. 1, or formed in the cap 16 as illustrated in FIG. 2. Accordingly, the following detailed description will be made in the context of the embodiment illustrated in FIG. 1. Nevertheless, those having ordinary skill in the art will appreciate that the following comments apply as equally well to the embodiment illustrated in FIG. 2.

The element assemblies 30 include a housing 36 and element leads 38 that extend through the housing 36. The housing 36 includes an opening 37 at the distal end that exposes the element 32 to the fuel. In addition, each of the sensors 28 includes leads 48 that extend between the element assemblies 30 and the common connector terminal 34. As best shown in FIG. 3 and unlike the fuel filters of the type generally known in the related art, where the leads simply pass through ports formed in the housing, the leads 40 of the sensors 28 of the present invention are encased in plastic substantially between the element assemblies 30 and the common connector 34, such that the leads 40 are sealed from contact with the fuel. In the representative embodiment illustrated in FIG. 1, the element assembly 30 is shown located so that it is exposed to fuel that passes through the outlet 24 of the fuel filter assembly 10. However, those having ordinary skill in the art will appreciate that the element assemblies 30 may be disposed anywhere within the fuel filter assembly 10 that is convenient for the purpose of sensing a condition of the fuel. As best shown in FIGS. 1-2, each of the sensor elements assemblies 30 is associated with at least one power lead 42 and at least one ground lead 44. More specifically, where a plurality of sensors assemblies 30 are employed in any given housing 12, each of the sensors assemblies 30 includes at least one lead 42 connected to a source of power and a common ground 44. The power leads 42 and the ground leads 44 are disposed in side-by-side relationship with respect to one another and encased in plastic between each of the sensor elements assemblies 30 and the common connector terminal 34. This particular arrangement is facilitated by the method of the present invention as will be described in greater detail below.

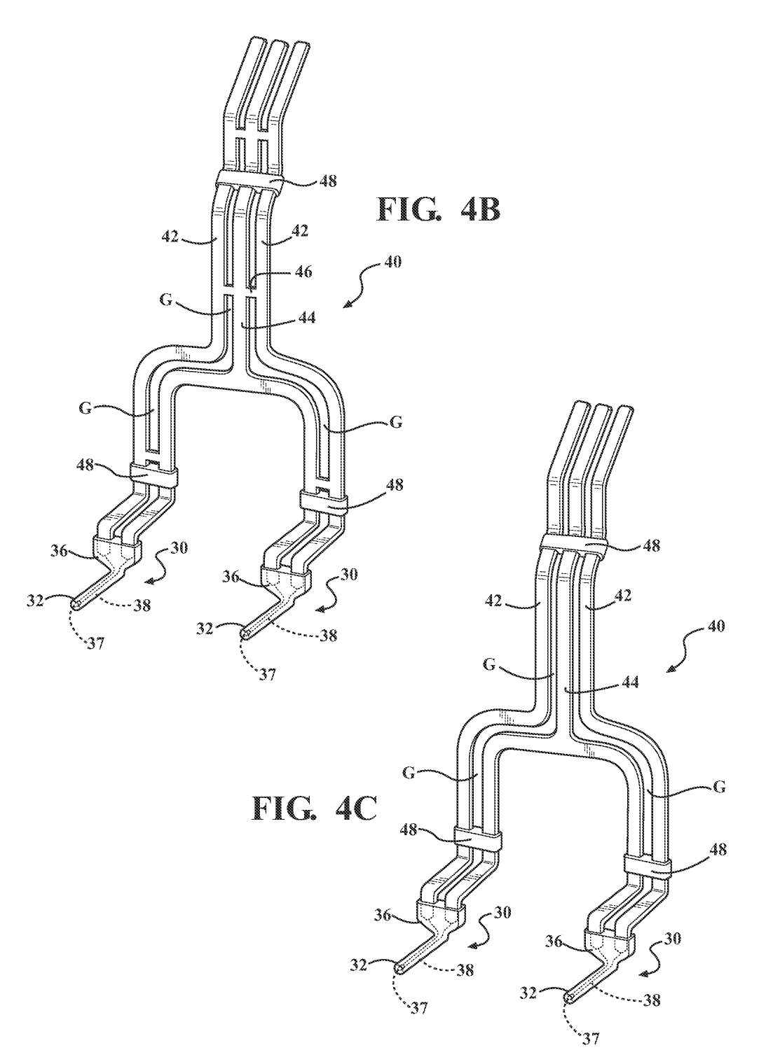

More specifically, the present invention is also directed toward a method of manufacturing a fuel filter 10 for an internal combustion engine. The method includes the steps of placing at least one sensor 28 including an element assemblies 30 and leads 42, 44 in a mold cavity. More specifically, the sensor 28 is typically placed in a mold half. The mold half is closed, typically by another mold half, so as to define a mold cavity. In the case of a fuel filter assembly 10 employing a plurality of sensors, each of the sensors 28 is placed in the mold half and the mold half is closed. Molten plastic is then injected into the mold cavity so as to define a filter housing 12 having an interior filter chamber 18 through which fuel may pass, so that each of the plurality of sensors 28 is exposed to at least one condition of the fuel passing through the filter chamber 18. In addition, each of the leads 42, 44 associated with the sensors 28 is encased in molded plastic. With particular reference to FIGS. 4A-4B, prior to placing the sensors 28 in any given mold half, the leads 40 are formed and attached to the sensor element 30. Forming the leads 40 includes stamping leads from a metal blank wherein the leads 34 are formed by the step of stamping the metal blank such that the leads 40 are disposed adjacent to one another so as to define a gap G therebetween. In addition, the adjacent leads 42, 44 are connected by metal links 46 formed from the metal blank. Thereafter, adjacent leads 42, 44 are connected by applying plastic bindings 48 that bridge the gap G between adjacent leads 42, 44 so that adjacent leads 42, 44 are connected to one another so as to define an integrated lead assembly, generally indicated at 40. Moreover, adjacent leads 42, 44 are electrically isolated from one another. To this end, and as best shown in FIG. 4C, the method further includes the steps of trimming the metal links 46 connecting adjacent leads 42, 44 so that the adjacent leads 42, 44 are electrically isolated from one another. Once the elements assemblies 30 have been attached to the ends of the leads 40, the leads may be placed in the mold cavity as described above. In addition to the step of stamping the leads 40 from a metal blank, the leads 40 may also be further formed so that they are shaped to conform to a particular contour necessary to interconnect the elements to the common connector terminal. Thus, as illustrated in FIGS. 4A-4C, the leads may be bent to follow the contour of the body 14 and the cap 16 of the housing 12 between the element assemblies 30 and the common connector terminal 34. In this way, and employing the method of manufacturing a fuel filter 10 for an internal combustion engine of the present invention, the added costs associated with threaded brass inserts, o-rings, and other fastening components, as well as the cost of assembling the sensor assembly to the housing are eliminated.

The present invention has been described in an illustrative manner. It is to be understood that the terminology that has been used is intended to be in the nature of words of description rather than of limitation. Many modifications and variations of the present invention are possible in light of the above teachings. Therefore, within the scope of the appended claims, the present invention may be practiced other than as specifically described.

What is claimed is:

1. A fuel filter assembly for an internal combustion engine, said assembly comprising:
a molded plastic housing defining an interior filter chamber, a filter element operatively supported in said filter chamber and through which fuel is passed;
at least one sensor operatively supported by said housing for sensing at least one condition of the fuel passing through said filter assembly, said sensor including an element exposed to the fuel, a common connector terminal adapted for electrical communication with a source of power and leads extending between said element and said common connector terminal, said leads being encased in plastic substantially between said element and said common connector terminal such that said leads are sealed from contact with the fuel.

2. The fuel filter assembly as set forth in claim 1 wherein said housing includes a body and a cap, said cap removably mounted to said body.

3. The fuel filter assembly as set forth in claim 2 wherein said common connector terminal is formed in said body.

4. The fuel filter assembly as set forth in claim 2 wherein said common connector terminal is formed in said cap.

5. The fuel filter assembly as set forth in claim 1 wherein said assembly includes a plurality of sensors operatively supported in said housing for sensing a plurality of conditions of the fuel passing through said filter assembly, each of said plurality of sensors including an element that is exposed to the fuel, a common connector terminal that is adapted to establish electrical communication between the source of power and each of said sensor elements, and leads extending between said element and said common connector terminal, said leads encased in plastic substantially between said element and said common terminal connector such that said leads are sealed from contact with the fuel.

6. The fuel filter assembly as set forth in claim 1 wherein said housing includes an inlet providing fluid communication between a source of fuel and said filter chamber, an outlet providing fluid communication between said filter chamber and the internal combustion engine, and a return port providing fluid communication between said filter chamber and the source of fuel.

7. The fuel filter assembly as set forth in claim 1 wherein each of said elements is associated with at least one power lead and one ground lead.

8. The fuel filter assembly as set forth in claim 5 wherein each of said sensors in said plurality of sensors includes one lead connected to a source of power and a common ground.

9. The fuel filter assembly as set forth in claim 8 wherein said power lead and said ground leads are disposed in side-by-side relationship with respect to one another and encased in plastic between each of said elements and said common connector terminal.

10. A fuel filter assembly for an internal combustion engine, said assembly comprising:
a molded plastic housing defining an interior filter chamber, a filter element operatively supported in said filter chamber and through which fuel is passed, said housing further including an inlet providing fluid communication between a source of fuel and said filter chamber, an outlet providing fluid communication between said filter chamber and the internal combustion engine, and a return port providing fluid communication between said filter chamber and the source of fuel;
a plurality of sensors operatively supported in said housing for sensing a plurality of conditions of the fuel passing through said filter assembly, each of said plurality of sensors including an element that is exposed to the fuel, a common connector terminal that is adapted to establish electrical communication between a source of power and each of said sensor elements, and leads extending between each of the said elements and said common connector terminals, said leads encased in plastic substantially between each of said elements and said common terminal connector such that said leads are sealed from contact with the fuel.

11. The fuel filter assembly as set forth in claim 10 wherein said housing includes a body and a cap, said cap removably mounted to said body.

12. The fuel filter assembly as set forth in claim 10 wherein said common connector terminal is formed in said body.

13. The fuel filter assembly as set forth in claim 10 wherein said common connector terminal is formed in said cap.

14. The method of manufacturing a fuel filter for an internal combustion engine, said method comprising the steps of:
placing at least one sensor including an element and leads in a mold cavity;
injecting molten plastic into said mold cavity so as to define a filter housing having a interior filter chamber through which fuel may pass and so that said element is exposed to fuel passing through the filter chamber and said leads are encased in molten plastic.

15. The method as set forth in claim 14 further including the step of:
placing the sensor in a mold half, closing the mold half to define a mold cavity, injecting molten plastic into the mold cavity to define the housing.

16. The method as set forth in claim 14 wherein the method further includes the steps of forming leads and attaching the leads to the sensor element.

17. The method as set forth in claim 16 wherein said step of forming the leads includes stamping the leads from a metal blank wherein the leads formed by the step of stamping are disposed adjacent to one another so as to define a gap therebetween and connected by metal links formed from the metal blank.

18. The method as set forth in claim 17 wherein the method further includes the steps of connecting adjacent leads by applying plastic bindings that bridge the gap between adjacent leads so that adjacent leads are connected to one another so as to define an integrated lead assembly wherein adjacent leads are electrically isolated from one another.

19. The method as set forth in claim 18 wherein the method further includes the step of trimming the metal links connecting adjacent leads so that adjacent leads are electrically isolated from one another.

20. The method as set forth in claim 14 further including the step of placing the plurality of sensors, each of which includes an element and leads, in a mold cavity;
injecting molten plastic into the mold cavity so as to define a filter housing having an interior filter chamber through which fuel may pass and so that each of the elements of each of the plurality of sensors is exposed to fuel passing through the filter chamber and each of the leads associated with each of the sensors is encased in molded plastic.
